(19) United States
(12) Patent Application Publication
(10) Pub. No.: US 2005/0168387 A1
(43) Pub. Date: Aug. 4, 2005

(54) Mechanically reconfigurable antenna for wireless access points

(76) Inventors: Greg Tangonan, Oxnard, CA (US); Carlos M. Oppus, Marikina City (PH); Jose Claro Monje, Santa Rosa (PH); Martin Paulo A. Arancon, Pasay City (PH); Joel Joseph Marciano, Quezon City (PH)

Correspondence Address: TOPE-MCKAY & ASSOCIATES, 23852 PACIFIC COAST HIGHWAY #311, MALIBU, CA, 90265, US

(21) Appl. No.: 10/954,617

(22) Filed: Sep. 29, 2004

Related U.S. Application Data
(60) Provisional application No. 60/506,599, filed on Sep. 29, 2003.

(51) Int. Cl. H01Q 1/24; H01Q 15/14

(52) U.S. Cl. 343/702; 343/912

(57) ABSTRACT

The present invention relates to a reconfigurable antenna for directing radiation from a wireless access point. More specifically, the present invention relates to a mechanically reconfigurable antenna for focusing a signal from the access point antenna in a desired direction.

### PRIORITY CLAIM

The present application claims the benefit of priority of U.S. Provisional Patent Application No. 60/506,599, filed Sep. 29, 2003, entitled “Mechanically Reconfigurable Antenna for Wireless Access Points.”

### BACKGROUND OF THE INVENTION

(1) Technical Field

The present invention relates to wireless communications, in particular to the antenna systems that will direct radiation to different sectors by mechanically or electrically switching reflector sections into play.

(2) Background

### SUMMARY OF THE INVENTION

The present invention relates to a reconfigurable antenna for directing radiation from a wireless access point. More specifically, the present invention relates to a mechanically reconfigurable antenna for focusing a signal from the access point antenna in a desired direction.

### BRIEF DESCRIPTION OF THE DRAWINGS

The objects, features and advantages of the present invention will be apparent from the following detailed descriptions of the preferred aspect of the invention in conjunction with reference to the following drawings, where:

FIG. 1. Base station with 90 degree reflector;

FIG. 2. Base station with 120 degree reflector;

FIG. 3. Base station with 180 degree reflector;

FIG. 4. Diversity antenna base station with two 90 degree reflectors;

FIG. 5. Actual trace of the antenna performance improvement with the 90 degree antenna in the actual deployment. Improvements of 6-12 dB were seen on average;

FIG. 6. CD carrying case used as a reflector antenna. Metal incorporated into the case forms the reflector;

FIG. 7. Paper corner used as a reflector antenna. Aluminum mesh sheets are incorporated into the paper corner. Simple construction allows easy bending to get different angled bends.

FIG. 8. Remotely placed base station antenna with a paper antenna and connector cable from the base station. We used the base station provided by the manufacturer and placed the antenna at the proper point in front of the reflector. So the whole base station can be hidden away and the variable sector antenna housed at a different place;

FIG. 9. Design options for WiFi base stations. The structures we have built can be incorporated lamp shades, behind picture frames, and within boxes or baskets. The angle of the base station reflector is optimized to match the house design for best performance of the WiFi deployment—signal to noise and overall throughput throughout the house. The incorporation into objects of aesthetic nature essentially camouflages or hides the antenna.

### DETAILED DESCRIPTION

The present invention relates to a reconfigurable antenna for directing radiation from a wireless access point. More specifically, the present invention relates to a mechanically reconfigurable antenna for focusing a signal from the access point antenna in a desired direction. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles, defined herein, may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention.

(1) Introduction

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Several experiments were performed to demonstrate reduction to practice of the fundamental ideas. We determined first that existing base stations could be outfitted with reflector antennas without even doing some optimization of the RF electronics feeding the antenna structure. This supports strongly our contention that the antenna concept is sound but also points a new low alternative to integration. The antennas can be effectively added to a base station and upgraded to become variable angle base stations with high performance. We added simple reflector antennas to base stations that are available commercially.

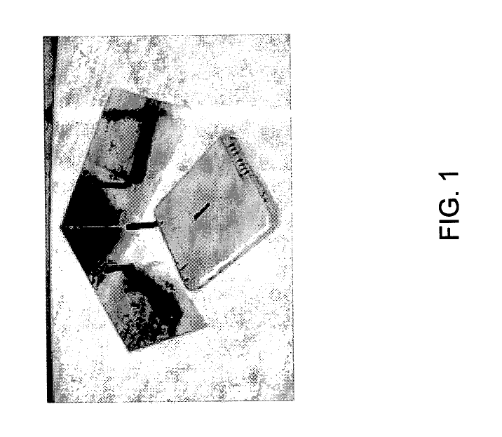

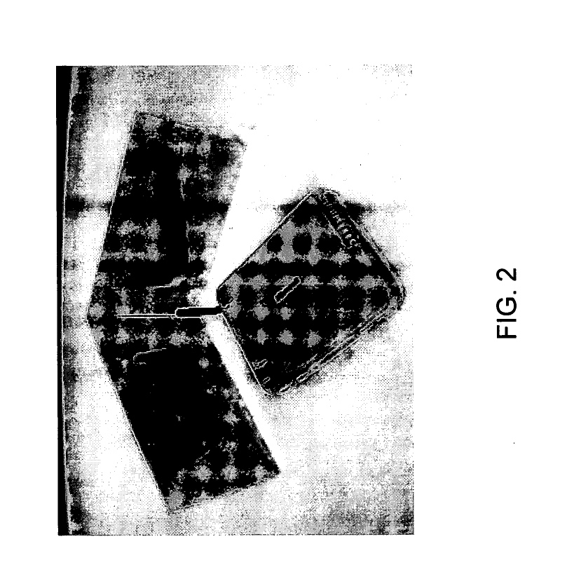

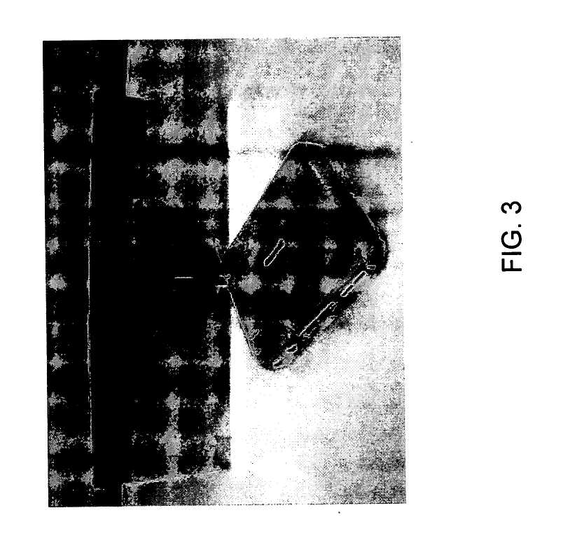

Shown in FIG. 1 through FIG. 4 are different antennas that have interfaced to existing commercial products.

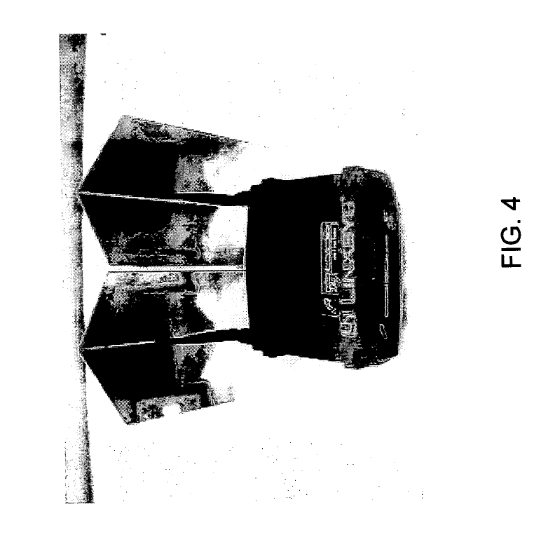

FIGS. 1 through 3 show a commercial Netgear base station with an external reflector added. The placement of the antenna for best gain is half lambda from the vertex of the reflector. Simple aluminum sheet is used for the metal sheet. Different antenna sizes were used for the studied in our experiments. We determined after studying antennas with faces of 15×20.3, 20.3×20.3, and 25.4×20.3 cm square, that the smallest face 15 cm gave the optimum response and minimum size. FIG. 4 shows a dual antenna base station with two 90 degree reflectors.

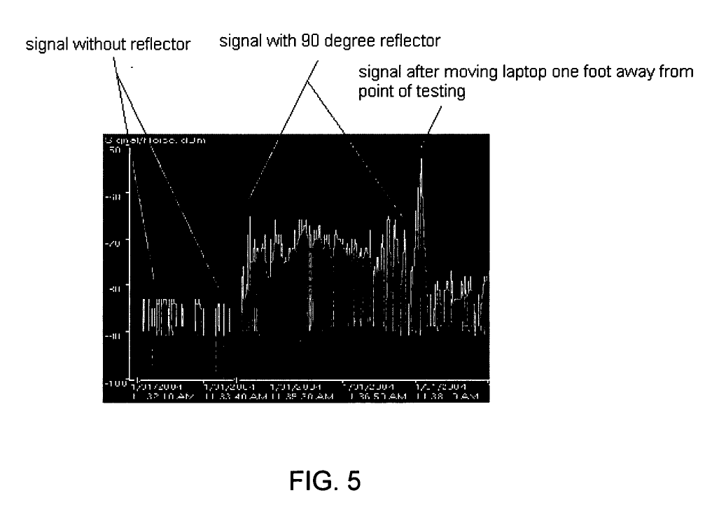

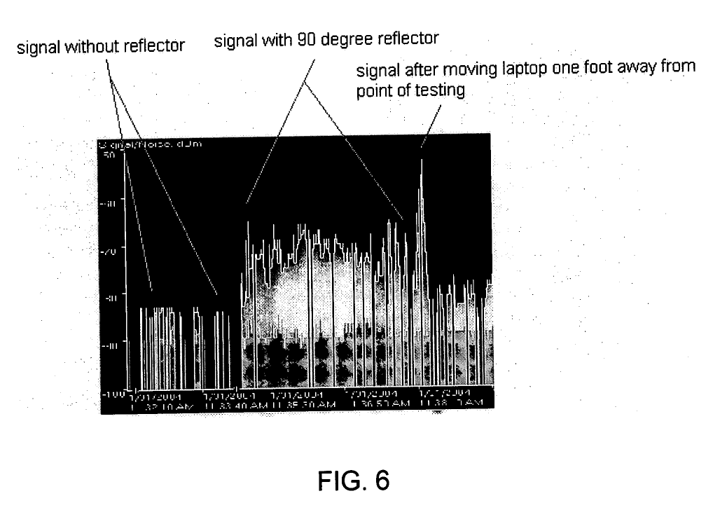

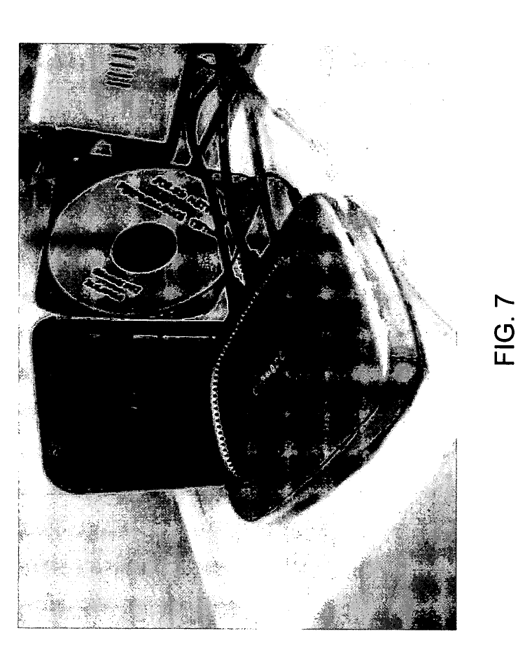

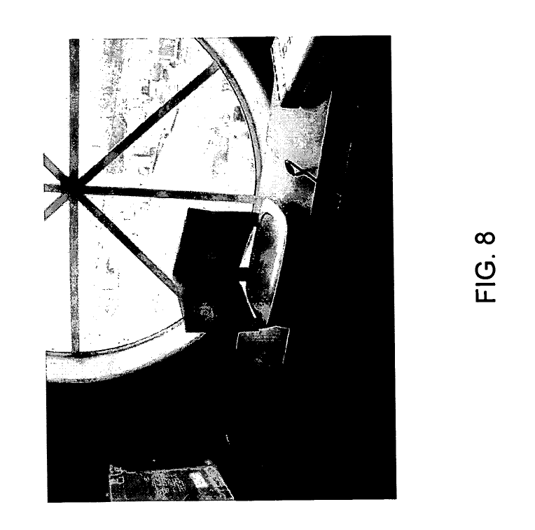

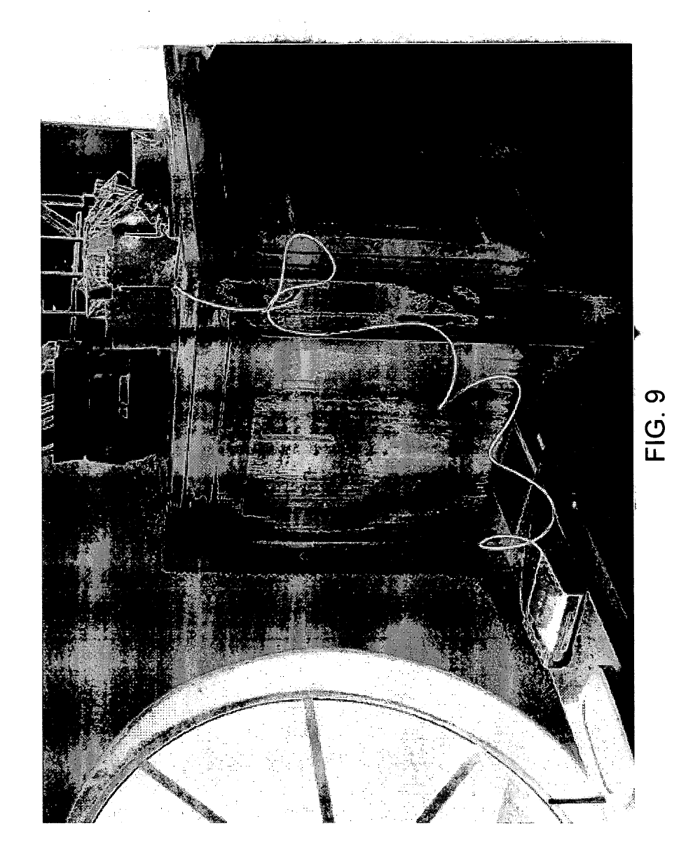

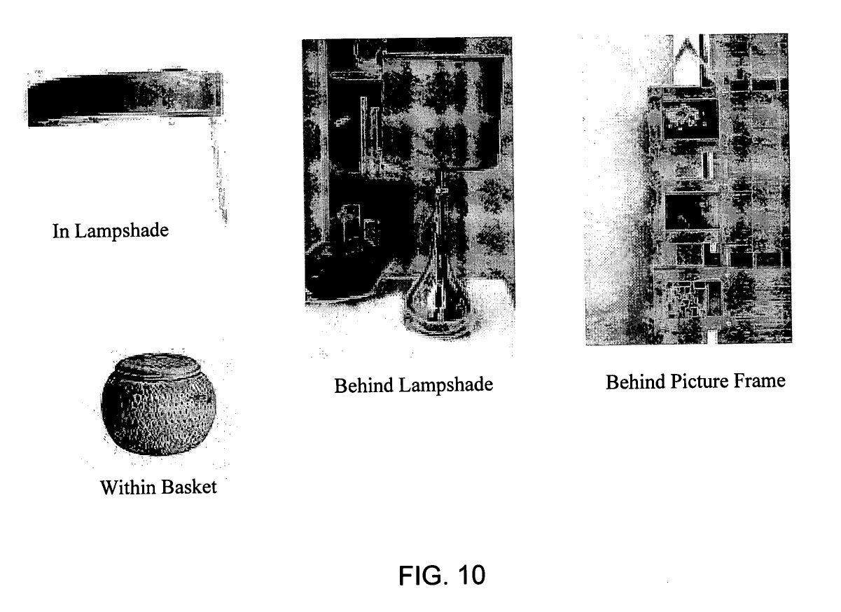

The performance of the antenna was measured using the power monitoring in an actual home setting is shown in FIG. 5. With the 90 degree antenna placed in a small room that had walls that were lossy at 2.4 GHz. Shown in FIG. 5 is the actual trace of the signal showing the improvement of 6 to 12 dB actually measured in demonstration. The users were able to connect in an upstairs bedroom with the antenna, whereas without the antenna the actual signal to noise ratio was not sufficient for good web connection.

Several designs were built and tested that performed very well with base stations but had the important new of being aesthetically pleasing to the eye. These designs may be the basis for new integrated base station designs that can be placed optimally for optimal WiFi performance and good aesthetics.

In the following figures we show how the base station antennas can be camouflaged in ordinary looking materials and can be incorporated into different structures.

1. A wireless base station reflector antenna comprising:
an RF-reflective, substantially planar surface configured for placement adjacent to a wireless access point antenna and tailored for focusing a signal from the access point antenna in a desired direction; whereby the surface may be placed proximate a wireless access point antenna and when a signal is broadcast from the antenna, the surface reflects the signal in a desired direction, thereby allowing a user to produce a tailorable signal pattern.

2. A wireless base station reflector antenna as in claim 1, wherein:
the substantially planar surface further comprises a support for supporting the substantially planar surface such that the substantially planar surface may be placed so that the surface is parallel to the antenna.

3. A wireless base station reflector antenna as in claim 1, wherein:
the planar surface is formed such that it may be folded into an acute angle to focus the signal, with a edges of the planar surface forming the support for supporting the substantially planar surface.

4. A wireless base station reflector antenna as in claim 1, wherein:
the reflective surface is formed of aluminum.
